(19) United States
(12) Patent Application Publication
(10) Pub. No.: US 2011/0092696 A1
(43) Pub. Date: Apr. 21, 2011

(54) High performance low residue guar for hydraulic fracturing and other applications

(75) Inventors: Asoke Kumar Deysarkar, Houston, TX (US); Atma Prakash Dadoo, Bhiwani (IN); Bela Kashyap, Bhiwani (IN); Darrell Vasut, Houston, TX (US)

(73) Assignees: PfP Technology, LLC., Houston, TX (US); Hindustan Gum & Chemicals Ltd, Bhiwana (IN)

(21) Appl. No.: 12/589,316

(22) Filed: Oct. 21, 2009

(51) Int. Cl. C08B 37/00

(52) U.S. Cl. 536/114

(57) ABSTRACT

A process and the guar produced thereby, the guar having superior performance in hydraulic fracturing applications. The guar is produced by first washing, soaking, and prehydrating guar gum splits in hot water. Calcium carbide which is then added to the mixture results in the production of acetylene gas, forcing the guar cells to open during shearing. Shearing the guar gum splits produces flakes, which are then ground and sieved. The fine guar particles produced are spherical in shape, with improved hydration viscosity, and better cross-linking performance than guars presently available. An operator can use twenty-percent (20%) less guar to create the same fracturing geometry, resulting in less formation damage. The improved guar can even be used at ultra low loadings. Further, it leaves less residue after break.

### FIELD OF THE INVENTION

The present invention relates to an improved guar produced by a unique process that improves its performance in hydraulic fracturing applications.

### BACKGROUND OF THE INVENTIONS

Hydraulic fracturing fluids are used to increase oil and gas production from subterranean formations. The viscous fluids are pumped at high pressure into well bores, fracturing the formations. For reasons know in the art, it is desirable for a fracturing fluid to have a high viscosity, to be able to carry proppants, and to have low residue after break.

Most fracturing fluids contain a hydrophilic polymer dissolved in a solvent, such as water. The water-soluble polymers most often used are polysaccharide, guar and guar derivatives, cellulosics and cellulosic derivatives, xanthan gum, modified starches, polyvinylsaccharides, and similar biopolymers. In order for a hydrophilic polymer (hereinafter often referred to simply as a “guar”) to reach a high level of viscosity, it must be properly hydrated. Typically, particles of the guar are dispersed in water. The guar can be mixed as a slurry in a carrier fluid to ensure it can be pumped and metered accurately during a treatment. Another option is to meter/pump dry guar powder directly into the hydration unit.

At present, the guar and water are added to a hydration unit at a very high flow rate. The goal is to ensure that the guar is hydrated to yield the optimal viscosity within three to five minutes. The residence time of three to five minutes is a function of pump rate and size of the hydration unit. For example, if the hydration unit has a capacity of 100 barrels (BBL) and pump rate is 30 BBL/minute, then the residence time in the hydraulic unit will be 100 BBL/30 BBL per minute=3.33 minutes.

After the guar is hydrated in the hydration unit, the solution is pumped into a blending unit or blender. In the blender, chemicals are added to ensure that the reservoir that is being fractured will not be damaged and that oil/gas will be produced efficiently once it is fractured. For example, 2% KCl may be added to minimize clay damage. One or more surfactants may be added to improve cleanup of the reservoir after treatment. A cross-linker (hereafter sometimes “x-linker”) can be added in the blender in order to cross-link the guar in water, resulting in a very high viscosity fluid which remains very stable for the duration of the pump time during the treatment at the reservoir. Depending on the type of guar used, the cross-linker can be borate-based or metal-based (e.g., Ti, Zr). Typically, borate-based cross-linkers are used for straight guars (not chemically-modified), while metal-based cross-linkers are used for chemically-modified guars (e.g., carboxy methyl guar, hydroxyl propyl guar, or carboxymethylhydroxy propyl guar).

A proppant is the final ingredient added to the cross-linked fluid, which carries the proppant to the reservoir during the pumping without having it settle out. The proppant replaces the tight reservoir with a permeable and conductive path. Once the proppant fills the fracture, the pumping stops, the cross-linked fluid is allowed to break with time, and the well is opened up to get rid of the fluid and then to start the production of oil/gas.

In order to improve the process, improved cross-linking agents and guars with greater intrinsic viscosities have been developed. Methods have been proposed to reduce the size of the hydration unit by increasing the speed of hydration or by the finding that a guar does not need to be completely hydrated before a cross-linker is added. What is still needed is an improved guar which is able to absorb water quickly and efficiently, resulting in numerous advantages in its utilization in fracturing fluids. In addition, the improved guar should have very low residue after break.

### SUMMARY OF THE INVENTION

The present application describes a novel process for making an improved guar with superior performance in fracturing applications.

Refined guar gum splits are washed, soaked, and prehydrated in hot water in typical fashion. In a novel step, calcium carbide is added to the mixture, resulting in the production of acetylene gas, forcing the guar cells to open during shearing. More water is added. The guar splits are sheared at high speed and high pressure, producing flaked guar splits, which are then ground and sieved. Most of the guar particles produced by the process (described herein in greater detail) are spherical in shape rather than having the elongated shape produced in processes presently used.

It is an object of the present invention to produce an improved guar with an improved hydration viscosity.

Another object of the present invention is to produce an improved guar that performs at least twenty-five percent (25%) better in cross-link tests than the best guar that is currently available.

Yet another object of the present invention is to provide an improved guar that, if used as a slurry, will not have any adverse effect in terms of slurry viscosity or slurry stability.

A further object of the present invention is to provide an improved guar that, for the same reservoir conditions downhole, would allow a user to create the same fracturing geometry while using twenty percent (20%) less guar, resulting in cost savings in mixing the fracturing fluid.

A still further object of the present invention is to provide an improved guar which, because less guar needs to be used in the fracturing fluid, will result in less formation damage, which, in turn, will mean increased production, a lower rate of depletion, and longer reservoir life.

One more object of the present invention is to provide an improved guar that can be used at ultra low loadings in cross-linked assist jobs.

Yet another object of the present invention is to provide an improved guar which can be proved to leave low residue after break.

Further objects and advantages of the guar produced by the invention process will become apparent from a consideration of the description, infra.

### BRIEF DESCRIPTION OF THE PREFERRED EMBODIMENT

The process for making the improved guar of the present invention has several points of novelty, setting it apart from the processes currently used.

The hydrophilic polymer described herein is a guar, but other polymers could be used, including guar derivatives, cellulosics and cellulosic derivatives, xanthan gum, modified starches, polyvinylsaccharides, and similar biopolymers.

In order to prepare the guar gum powder, refined guar gum splits are washed, soaked, and prehydrated in hot water, maximizing water penetration, until almost all of the guar cells are exposed. Calcium carbide is added to the water mixture, resulting in the production of acetylene gas while undergoing the following exothermic reaction:

CaC₂+H₂O →C₂H₂↑+CaCO₂

Water is added to the guar mixture to open the guar splits further and to increase the moisture content of the splits to approximately 50-51%. The moist splits are passed through two motor-driven roll mills, moving in opposite directions, at high speed and high pressure, stretching the guar molecules and shearing them. During this step, the acetylene gas forces the splits to open further. The flaked guar splits produced are ground to maximize their surface area and are then dried. The resulting guar powder is sieved, using screens, to remove larger particles and to produce particles that are between 20-74 microns in size, instead of approximately 200 microns, as in presently-used processes.

Approximately 95% of the particles of guar powder produced by this process are spherical in shape, rather than elongated, as is customary in processes presently used. The fine particles hydrate more quickly than larger particles would. The improved hydration viscosity of the guar comes into play when the powder is added to water. It was also found that, even though the particle size is smaller than typical, the polymer chains produced by this process are longer than typical, and chain length is maintained throughout the process. In addition, the molecular weight is higher than that of the larger particles produced in presently-used processes. Finally, it was determined that the spherical shape of the particles results in a lower slurry viscosity, so that the powder can be pumped more easily. The result is a fast-hydrating and high yield guar.

In order to simulate the field hydration process, three different test methods were performed. The base line guar used, called PfP 4045, is currently the best guar available. PfP 4045 was produced by mixing 20 pounds of guar per 1,000 gallons of water (with 2% KCl) (0.24% w/w of guar in water) in a blender for 30 minutes. A clay stabilizer, such as ammonium chloride, is added to the fluid and mixed for 30 seconds. This cross-linked fluid is loaded in a Fann 50 viscometer to measure the viscosity profile as a function of time, temperature and shear rate. The improved guar of the present invention, called PfP 5055, was prepared exactly the same way, using PfP 5055 instead of PfP 4045. The resulting cross-linked fluid is loaded in a Fann 50 viscometer to measure the viscosity profile as a function of time, temperature and shear rate.

The comparative hydration viscosity data for PfP 5055 and PfP 4055 are shown in Table 1. The RPM's ranged from 1,000 to 3,000, and the mixing time from 30 seconds to 2 minutes. Method 1 used low RPM, with the highest mixing time. Method 2 used medium RPM with a medium mixing time. Method 3 used the highest RPM with a low mixing time. Viscosity was measured at intervals of 3, 4, 5, 10, 30, and 60 minutes.

TABLE 1
COMPARATIVE HYDRATION VISCOSITY DATA

| | Method 1 | Method 1 | Method 2 | Method 2 | Method 3 | Method 3 |
|---|---|---|---|---|---|---|
| Time, Minutes | PfP 5055 | PfP 4045 | PfP 5055 | PfP 4045 | PfP 5055 | PfP 4045 |
| 3 | 49.8 | 42.2 | 47.4 | 41.8 | 41.0 | 36.8 |
| 4 | 51.5 | 43.8 | 49.0 | 43.0 | 44.4 | 39.4 |
| 5 | 52.7 | 44.2 | 50.0 | 43.6 | 46.0 | 41.0 |
| 10 | 54.2 | 44.8 | 51.6 | 45.4 | 48.6 | 44.0 |
| 30 | 54.6 | 45.2 | 52.6 | 46.2 | 51.0 | 45.0 |
| 60 | 54.8 | 45.8 | 53.8 | 47.0 | 52.4 | 45.4 |

As Table 1 shows, using a typical laboratory hydration process such as Method 1, PfP 4045 will have a hydration viscosity at 3 minutes of 40±2 cP, and, at 60 minutes, a hydration viscosity of 45±2 cP. Using the same hydration process, PfP 5055 will have a 3 minute viscosity of 50 cP, and a 60 minute viscosity of 55 cP. In fact, Table 1 shows that, independent of the laboratory mixing method used, PfP 5055 always has a higher hydration viscosity than PfP 4055 at each time interval measured, showing that PfP 5055 clearly outperforms the best guar currently available.

PfP 5055 and PfP 4045 were also compared in active performance (cross-link) tests. The tests used medium guar loading of 20 pounds per 1,000 gallons of water. Again, all tests were carried out using a commonly-available clay stabilizer, buffer, and cross-linker. The pH of the mixtures measured between 9.5 to 12.0. Viscosity was measured at 2 hours or more and at 106 sec⁻¹. The results are tabulated in Table 2.

TABLE 2
COMPARATIVE CROSS-LINK PERFORMANCE

| Test No. | | | | |
|---|---|---|---|---|
| Guar Used | X-Link | | | |
| Temperature | Viscosity | | n′ | Comments |
| Test #1523 | 350-400 | cP | Very shear | This fluid is |
| S-PfP 4045 | | | thinning & | very stable for |
| 200° F. | | | n′ < 1 | over 2 hours; |
| | | | | the reference |
| | | | | performance |
| Test #1520 | 475-500 | cP | Very shear | This fluid is |
| N-PfP 5055 | | | thinning & | very stable for |
| 200° F. | | | n′ < 1 | over 2 hours, |
| | | | | but at 25% |
| | | | | higher level |
| | | | | of x-link |
| | | | | viscosity |
| Test #1524 | ≈300 | cP | Very shear | Stable x-linked |
| S-PfP 4045 | | | thinning & | fluid |
| 250° F. | | | n′ < 1 | |
| Test #1525 | ≈450 | cP | Very shear | Stable x-linked |
| N-PfP 5055 | | | thinning & | fluid |
| 250° F. | | | n′ < 1 | |
| Test #1526 | — | | — | Not a stable |
| S-PfP 4045 | | | | x-linked |
| 300° F. | | | | fluid; it broke |
| | | | | within 20 |
| | | | | minutes |
| Test #1527 | — | | — | Not a stable |
| N-PfP 5055 | | | | x-linked |
| 300° F. | | | | fluid; it broke |
| | | | | within 30 |
| | | | | minutes |
| Test #1530 | ≈400 | cP | Very shear | Stable x-linked |
| S-PfP 4045 | | | thinning & | fluid |
| with high temperature | | | n′ < 1 | |
| stabilizer | | | | |
| 300° F. | | | | |
| Test #1532 | ≈650 | cP | Very shear | Stable x-linked |
| N-PfP 5055 | | | thinning & | fluid |
| with high temperature | | | n′ < 1 | |
| stabilizer | | | | |
| 300° F. | | | | |

As Table 2 clearly shows, PfP 5055 outperforms PfP 4045 in all tests by as much as twenty-five percent (25%). The tests also showed that, above 250° F., a high 7 temperature stabilizer was needed in order to have a stable cross-linked fluid.

Another important property that must be considered is the slurry viscosity of the improved guar, i.e., is it low enough so the guar is pumpable, even at low temperatures. Table 3-A shows comparative slurry viscosity data for the guar of the present invention, PfP 5055, and the hitherto best available guar, PfP 4045. Both guar powders were formulated to make slurries using clean zero aromatic mineral oil, and at two different loadings, 4 lbs/gal. and 4.5 lbs/gal. Each slurry viscosity was measured using two methods: Fann 35 at 300 rpm or 511 sec⁻¹ (at 75±2° F.); and low rpm Brookfield viscometer (at 80° F. and at 40° F.). The results are shown below:

TABLE 3-A
COMPARATIVE SLURRY VISCOSITY DATA

| | PfP 5055 | | PfP-4045 | |
|---|---|---|---|---|
| | Viscosity Using | | Viscosity Using | |
| Polymer | Fann 35 | Viscosity Using | Fann 35 | Viscosity Using |
| Loading | @ 75 ± 2° F. | Brookfield | @ 75 ± 2° F. | Brookfield |
| 4#/gal | 139 cP | @ 80° F.: 640 cP | @ 195 cP | @ 80° F.: 830 cP |
| | | @ 40° F.: 1408 cP | | @ 40° F.: 1600 cp |
| 4.5#/gal | 316 cP | @ 80° F.: 960 cP | @ 280 cP | @ 80° F.: 2816 cP |
| | | @ 40° F.: 2496 cP | | @ 40° F.: 11520 cP |

As the table shows, there is no practical difference between PfP 5055 and PfP 4045 in terms of slurry viscosity. In general, the slurry viscosity values are directionally higher for PfP 5055 compared to PfP 4045. However, the slurry viscosities for both guars are low enough to be pumpable, even at temperatures as low as 40° F.

Tests were also performed to obtain hydration viscosity values when a slurry rather than a powder form was used as a source of the guar. The tests were run by mixing either PfP 5055 or PfP 4045 in 500 ml. DI water, 2% KCl. The results are shown in Table 3-B.

TABLE 3-B
COMPARATIVE SLURRY HYDRATION VISCOSITY DATA

| Polymer | | | | | | |
|---|---|---|---|---|---|---|
| Loading | PfP-5055 | | | PfP-4045 | | |
| 4#/gal | Mix @ 1500 rpm for 150 secs. in Waring | | | Mix @ 2000 rpm for 120 secs. in Waring | | |
| | blender. Fann 35, R1B1, @ 300 rpm. | | | blender. 30 lb./1000 gal. system. | | |
| | Measured at 511 sec ⁻¹ at 80° F. | | | Measured at 511 sec ⁻¹ at 80° F. | | |
| | | 20# | 40# | | 30# | 40# |
| | Viscosity 3′ | 16.8 cP | 48.4 cP | Viscosity 3′ | 25.6 cP | 42 cP |
| | Viscosity 5′ | 18.2 cP | 50.4 cP | Viscosity 5′ | 27.4 cP | 44 cP |
| | Viscosity 10′ | 19.8 cP | 53.6 cP | Viscosity 10′ | 28.6 cP | 46 cP |
| | Viscosity 60′ | 21.2 cP | 56.2 cP | Viscosity 60′ | 29.8 cP | 48 cP |
| | pH 30′ | 6.62 | 6.63 | pH 30′ | 7.27 | 7.29 |
| 4.5#/gal | Mix @ 2000 rpm for 120 secs. in Waring | | | Mix @ 2000 rpm for 120 secs. in Waring | | |
| | blender. 30 lb./1000 gal. system. | | | blender. 30 lb./1000 gal. system. | | |
| | Measured at 511 sec ⁻¹ at 80° F. | | | Measured at 511 sec ⁻¹ at 80° F. | | |
| | | 30# | 40# | | 30# | 40# |
| | Viscosity 3′ | 28.4 cP | 47.8 cP | Viscosity 3′ | 23.8 cP | 38.9 cP |
| | Viscosity 5′ | 31.2 cP | 51.0 cP | Viscosity 5′ | 25.0 cP | 40.8 cP |
| | Viscosity 10′ | 33.4 cP | 52.8 cP | Viscosity 10′ | 26.1 cP | 42.0 cP |
| | Viscosity 60′ | 35.0 cP | 55.2 cP | Viscosity 60′ | 27.8 cP | 44.7 cP |
| | pH 30′ | 6.56 | 6.53 | pH 30′ | 6.9 | 7.55 |

The results demonstrate that hydration viscosity values are the same whether the polymer is hydrated from a dry powder or from a slurry. In other words, using a slurry does not have a negative impact on the performance of the guar in terms of hydration.

Tests were also performed in order to measure hydration viscosities of the guar of the present invention, PfP 5055, with the best guar presently available, PfP 4045, and another lower grade guar, PfP 3040¹. The guar was mixed in 250 ml. DI water, 2% KCl, at 1500 RPM, for 2 minutes 30 seconds. Hydration viscosities were measured at 3 minutes, 10 minutes, and 60 minutes. Guar loadings of 40 ppt, 35 ppt, 30 ppt, 20 ppt, 17 ppt, 15 ppt, and 10 ppt were used in the tests. The viscosities are recorded in the first three columns of Table 4, below. Th hydration data are normalized with respect to PfP 5055, and the results are shown in columns four through six of Table 4, below. ¹PfP 3040 is a historical product with a lower hydration viscosity compared to the current standard guar, PfP 4045.

TABLE 4
NORMALIZED HYDRATION DATA

| | | | | % Hydration | | |
|---|---|---|---|---|---|---|
| | Viscosity | | | (compared to PfP 5055) | | |
| Time, Minutes | PfP 3040 | PfP 4045 | PfP 5055 | PfP 3040 | PfP 4045 | PfP 5055 |
| Loading, ppt ==> | 40# | 40# | 40# | 40# | 40# | 40# |
| 3 | 35.2 | 39.0 | 48.8 | 72.1% | 79.9% | 100.0% |
| 10 | 38.2 | 42.0 | 51.8 | 73.7% | 81.1% | 100.0% |
| 60 | 39.4 | 43.2 | 53.0 | 74.3% | 81.1% | 100.0% |
| Loading, ppt ==> | 35# | 35# | 35# | 35# | 35# | 35# |
| 3 | 28.0 | 33.0 | 39.0 | 71.8% | 84.6% | 100.0% |
| 10 | 30.0 | 35.8 | 41.8 | 71.8% | 85.6% | 100.0% |
| 60 | 31.2 | 36.6 | 42.6 | 73.2% | 85.9% | 100.0% |
| Loading, ppt ==> | 30# | 30# | 30# | 30# | 30# | 30# |
| 3 | 22.2 | 25.2 | 30.0 | 74.0% | 84.0% | 100.0% |
| 10 | 23.6 | 27.2 | 34.4 | 72.8% | 84.0% | 100.0% |
| 60 | 24.4 | 28.0 | 32.8 | 74.4% | 85.4% | 100.0% |
| Loading, ppt ==> | 20# | 20# | 20# | 20# | 20# | 20# |
| 3 | 10.2 | 13.0 | 16.2 | 63.0% | 80.2% | 100.0% |
| 10 | 12.2 | 14.4 | 17.4 | 70.1% | 82.8% | 100.0% |
| 60 | 12.8 | 14.8 | 18.0 | 71.1% | 82.2% | 100.0% |
| Loading, ppt ==> | 17# | 17# | 17# | 17# | 17# | 17# |
| 3 | 9.0 | 10.2 | 12.4 | 72.6% | 82.3% | 100.0% |
| 10 | 9.8 | 11.0 | 13.4 | 73.1% | 82.1% | 100.0% |
| 60 | 10.2 | 11.4 | 13.8 | 73.9% | 82.6% | 100.0% |
| Loading, ppt ==> | 15# | 15# | 15# | 15# | 15# | 15# |
| 3 | 7.4 | 8.4 | 10.0 | 74.0% | 84.0% | 100.0% |
| 10 | 8.2 | 9.2 | 11.2 | 73.2% | 82.1% | 100.0% |
| 60 | 8.6 | 9.6 | 11.4 | 75.4% | 84.2% | 100.0% |
| Loading, ppt ==> | 10# | 10# | 10# | 10# | 10# | 10# |
| 3 | 4.4 | 4.8 | 5.8 | 75.9% | 82.8% | 100.0% |
| 10 | 5.0 | 5.4 | 6.4 | 78.1% | 84.4% | 100.0% |
| 60 | 5.2 | 5.6 | 6.6 | 78.8% | 84.8% | 100.0% |

As Table 4 shows, with respect to PfP 5055, PfP 4045 yields to abut 82±1%, while PfP 3040 yields to about 73±1%. These two conclusions are valid at 3 minute, 10 minute, and 60 minute readings. The improvement in hydration viscosity is substantial: PfP 5055 is over 20% better than PfP 4045 and it is over 35% better than PfP 3040.

Tests to derive cross-linked data for PfP 5055, PfP 4045, and PfP 3040 at several polymer loadings were performed at 200° F. with Fann 50 viscometer. Measurements were recorded at intervals up to 120 minutes. Polymer loadings used were 10 ppt, 12 ppt, 15 ppt, 20 pt, and 25 ppt (for PfP 3040). The results are shown in Table 5 below:

TABLE 5
COMPARATIVE CROSS-LINKED VISCOSITY
A. 20 ppt loading - PfP 5055, PfP 4045, and PfP 3040

| | Cross-Linked Viscosity | | |
|---|---|---|---|
| Time (min.) | PfP 5055 | PfP 4045 | PfP 3040 |
| 0 | 0 | 0 | 0 |
| 15 | 175 | 260 | 167 |
| 25 | 220 | 320 | 225 |
| 30 | 310 | 357 | 264 |
| 40 | 450 | 400 | 309 |
| 60 | 496 | 400 | 303 |
| 90 | 497 | 426 | 328 |
| 120 | 502 | 418 | 321 |

B. 20 ppt loading - PfP 5055; 25 ppt loading - PfP 3040

Cross-Linked Viscosity

| Time (min) | PfP 5055 | PfP 3040 |
|---|---|---|
| 0 | 0 | 0 |
| 15 | 175 | 238 |
| 25 | 220 | 334 |
| 30 | 310 | 416 |
| 40 | 450 | 477 |
| 60 | 496 | 522 |
| 90 | 497 | 470 |
| 120 | 502 | 516 |

C. 15 ppt loading - PfP 5055, PfP 4045, and PfP 3040

| | Cross-Linked Viscosity | | |
|---|---|---|---|
| Time (min.) | PfP 5055 | PfP 4045 | PfP 3040 |
| 0 | 0 | 0 | 0 |
| 15 | 150 | 93 | 97 |
| 25 | 220 | 175 | 173 |
| 30 | 245 | 210 | 176 |
| 40 | 275 | 212 | 182 |
| 60 | 282 | 221 | 170 |
| 90 | 291 | 238 | 153 |
| 120 | 285 | 241 | 145 |
| 140 | 294 | 250 | 132 |

D. 12 ppt loading - PfP 5055, PfP 4045, and PfP 3040

| | Cross-Linked Viscosity | | |
|---|---|---|---|
| Time (min.) | PfP 5055 | PfP 4045 | PfP 5040 |
| 0 | 0 | 0 | 0 |
| 15 | 150 | 94 | 91 |
| 25 | 175 | 167 | 110 |
| 30 | 178 | 159 | 91 |
| 40 | 200 | 157 | 82 |
| 60 | 189 | 132 | 57 |
| 90 | 183 | 108 | 25 |
| 120 | 167 | 87 | 0 |
| 140 | 155 | 83 | 0 |

E. 10 ppt loading - PFP 5005 (2 runs) and PfP 4045 (2 runs)

| | Cross-Linked Viscosity | | | |
|---|---|---|---|---|
| Time (min.) | PfP 5055(1) | PfP 5055(2) | PfP 4045(1) | PfP 4045(2) |
| 0 | 0 | 0 | 0 | 0 |
| 15 | 97 | 78 | 95 | 61 |
| 30 | 120 | 122 | 25 | 40 |
| 40 | 108 | 112 | 10 | 21 |
| 60 | 82 | 89 | 4 | 0 |
| 90 | 57 | 59 | 0 | 0 |
| 120 | 35 | 33 | 0 | 0 |
| 140 | 15 | 26 | 0 | 0 |

As Table 5 shows, PfP 5055 would perform best in the field in terms of cross-linked viscosity and will result in more efficient cross-linked fluids. A review of the data in Table 5 shows the following:
1. At 20 ppt. loading, the cross-linked viscosity measurement for PfP 5055 is about 20±4% higher than that of PfP 4045, at all times measured.
2. At 20 ppt. loading, the cross-linked viscosity measurement for PfP 5055 is about 38±4% higher than that of PfP 3040, at all times measured.
3. At 15 ppt. loading, the cross-linked viscosity for PfP 5055 is only somewhat higher than the cross-linked viscosity of PfP 4045 at the start of the test.
4. At 15 ppt. loading, as time passes, the cross-linked viscosity of PfP 5055 grows to more than 50% higher than that of PfP 3040.
5. At 12 ppt. loading, overtime, PfP 3040 becomes completely unstable, while PfP 5055 remains very stable.
6. At 10 ppt loading, over time, PfP 3040 becomes unstable, while PfP 5055 remains stable. This test was rerun to ensure that the data is reproducible.

The results show that the polymer loading can be lowered by 15 to 20% when using the present invention, PfP 5055, compared to polymer loading of the current best-available polymer.

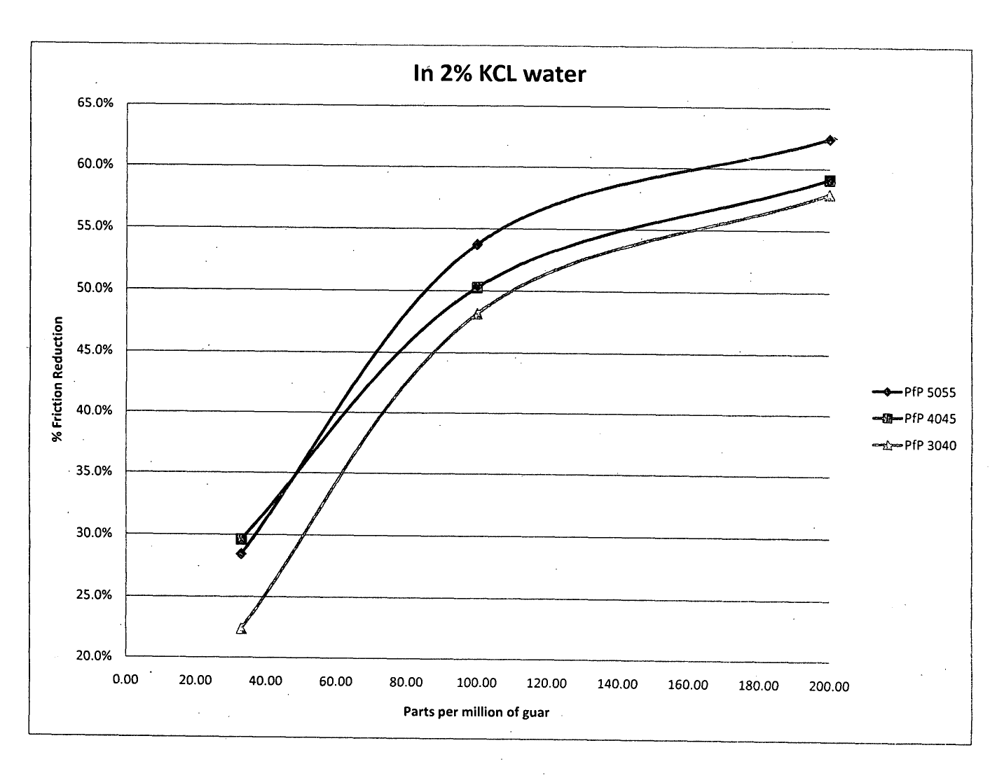

As Table 5, above, shows, for low loading; at 200° F., one can go as low as 10 ppt. loading if PfP 5055 is used. Low polymer loading can be desirable in certain fracturing jobs. For example, using PfP 5055 can mean more proppant can be carried, compared to water containing only friction reducer. Testing also showed that PfP 5055 can lower friction pressure like normally-used polyacryl amide (PAM), a friction reducer. In fact, PFP 5055 lowers friction pressure more efficiently than other historical polymers, as shown in FIG. 1; the curved lines result from plotting the parts per million of guar in 2% KCl in water against the percentage of friction reduction achieved by the three different guars, PfP 3040, PfP 4045, and PfP 5055. PfP 5055 can reduce wear and tear on surface equipment by providing “Viscosity Assist” lubrication. As Table 5 shows, PfP 5055 would perform best in the field in terms of cross-link viscosity and will result in more efficient cross-linked fluids.

As a result of the findings in Table 5, testing was undertaken using ultra low polymer loading, that is, polymer loading below 10 ppt, all the way down to 5 ppt. In the field of hydraulic fracturing, operators may find ways to effectively use guar loadings lower than 10 ppt by using PfP 5055 with a dense cross-linker. This use of very low guar concentrations is called a “cross-linked assist” job. Presently, using a polymer such as PfP 4045, the current standard, an operator can use as low as 10-12 ppt loading with a dense cross-linker. The results are even better using PfP 5055. As shown in Table 6 below, tests were performed in order to determine quantitatively the effectiveness of PfP 5055 in cross-linked assist jobs. Using 2 gpt of a typical borate cross-linker, an operator can perform a cross-linked assist job using only 7 ppt of PfP 5055 guar and still achieve fair cross-linking behavior. Using an even lower loading of 5 ppt of PfP 5055 guar yields at least weak cross-linking behavior.

TABLE 6
ULTRA LOW LOADING PERFORMANCE USING PfP 5055
A. PfP BXL 0.2 testing:

| Polymer loading: | 20 ppt | | 10 ppt | | 7 ppt | | 5 ppt | |
|---|---|---|---|---|---|---|---|---|
| PfP 8XL 0.2 | 2 | gpt(.5 ml) | 2 | gpt(.5 ml) | 2 | gpt(.5 ml) | 2 | gpt(.5 ml) |
| amount: | | | | | | | | |
| PfP BXL 0.2 pH: | 13.27 | | 13.27 | | 13.27 | | 13.27 | |
| pH of X-linked: | 10.30 | | 10.42 | | 10.52 | | 10.55 | |
| Cross-Linking | 10 | seconds | 30 | sec | 4 | min | 17 | min |

| | | | | |
|---|---|---|---|---|
| Time: | | | | |
| Cross-linking | Strongly cross- | Good | Fair | Weak |
| Behavior: | linked | | | |

B. PfP BXL 0.2 testing:

| Polymer loading: | 20 ppt | | 10 ppt | | 7 ppt | | 5 ppt | |
|---|---|---|---|---|---|---|---|---|
| PfP BXL 0.2 | 0.25 | ml | .25 | ml | .60 | ml | .60 | ml |
| amount: | | | | | | | | |
| PrP BXL 0.2 pH: | 13.27 | | 13.27 | | 13.27 | | 13.27 | |
| pH or X-linked: | 9.96 | | 10.08 | | 10.60 | | 10.62 | |
| Cross-Linking | 10 | seconds | 1 | min | 3 | min | 14 | min |

| | | | | |
|---|---|---|---|---|
| Time: | | | | |
| Cross-linking | Strongly cross- | Good | Fair | Weak |
| Behavior: | linked | | | |

C. PfP BXL 0.2 testing:

| Polymer loading: | 7 ppt | 7 ppt | | 5 ppt | | 5 ppt | |
|---|---|---|---|---|---|---|---|
| PfP BXL 0.2 | .75 ml | 1.00 | ml | .75 | ml | 1.50 | ml |
| amount: | | | | | | | |
| PfP BXL 0.2 pH: | 13.27 | 13.27 | | 13.27 | | 13.27 | |
| pH of X-linked: | 10.64 | 11.11 | | 10.67 | | 11.16 | |
| Cross-Linking | 2 min 10 sec | 5 | min | 8 | min | 8 | min |
| Time: | | | | | | | |

| Cross-linking | Fair | Fair | Weak | Not Cross-linked |
|---|---|---|---|---|
| Behavior: | | | | Broken |

Finally, the improved polymer of the present invention, PfP 5055, has been evaluated with respect to Residue after Break, which is a key parameter in judging the performance of a guar. Specifically, the lower the residue, the better the guar's performance is with respect to oil and gas production. The following test procedure was used to evaluate PfP 5055, PfP 4045, and PfP 3040:

Weigh 99.90 g. of D.I. water into a 250 ml. beaker with a 1 inch magnetic stir bar. Place the beaker on a magnetic stirrer and stir to just below the splash point. Weigh 0.110 g. of the guar being tested for residue after break, and add the guar slowly to the water to avoid lumping. Mix for 2 minutes. Add 2 drops of formic acid and cover with a double layer of plastic wrap and place a rubber band around the beaker to secure the wrap to the sides of the beaker. Reduce mixing speed to about ½ the original speed and mix for an additional 60 minutes. Place the solution in a water bath preset to 80±5° C. for 48 hours. Weigh one circle of 1.0 micro pore size glass filter paper and then place it on the base screen of the Whattman Filtration assembly, making certain to completely wet and center the filter paper. Attach the complete assembly and start the vacuum pump. Pour the digested solution into the cell. Rinse the beaker with 10 to 20 ml. distilled water. Cover the cell with folded A4 size paper and pressurize to the maximum. After all the liquid has passed through the filter paper, depressurize the assembly and remove the base screen and filter paper from the assembly. Using forceps, place the filter paper on the petri dish and keep it in the over set at 80±5° C. for 2 hours. Cool and weigh the filter paper. The percent residue after break is calculated as follows:

% RAB=Weight of RAB (grams)×100

The results for the three polymers are as follows:

| Polymer | Residue After Break |
|---|---|
| PfP 5055 | 4.95% |
| PfP 4045 | 9.10% |
| PfP 3040 | 16.25% |

The results show that the historical product, PfP 3040, has the highest Residue After Break, and that the improved PfP 5055 is a far superior product compared to PfP 4045, the current standard product. The percent Residue after Break for PfP 5055 is dramatically lower than that for both PfP 4045 and PfP 3040.

Overall, the tests show that the improved guar, PfP 5055, performs better than other currently-available guars. PfP 5055 is the fastest hydrated product, has the highest cross-linked viscosity, and it leaves the lowest amount of residue.

We claim:

1. A method of preparing improved guar particles for use in hydraulic fracturing applications comprising the following steps:
(a) washing, soaking, and prehydrating refined guar gum splits in hot water in order to maximize water penetration and to expose guar cells;
(b) adding calcium carbide to the hot water, thereby producing acetylene gas that forces the guar cells to open during step (d);
(c) adding more water;
(d) shearing the guar gum splits at high speed and high pressure in order to stretch the guar molecules and to produce flaked guar splits;
(e) grinding the flaked guar splits; and
(f) sieving the flaked guar splits, separating unwanted large particles from usable fine guar particles.

2. The method of claim 1 wherein step (a) is performed until most of the guar gum splits are exposed.

3. The method of claim 1 wherein in step (c), water is added until the guar splits have a moisture content between 50-51%.

4. The method of claim 1 wherein the means of performing step (d) are motor-driven roll mills, moving in opposite directions, at high speed and high pressure.

5. The method of claim 1 wherein the sieving operation claimed in step (f) is performed until the usable fine guar particles are between 20 to 74 microns in size.

6. A guar powder comprising a multitude of fine guar particles prepared in accordance with claim 1.

7. The guar powder of claim 6 wherein 95% of the guar particles are spherical in shape.

8. The guar powder of claim 6 wherein the guar powder is used in ultra low loading applications.
